(19) United States
(12) Patent Application Publication
(10) Pub. No.: US 2025/0030201 A1
(43) Pub. Date: Jan. 23, 2025

(54) ELECTRICAL CONNECTOR WITH HIGH FREQUENCY PERFORMANCE

(71) Applicants: FUDING PRECISION INDUSTRY (ZHENGZHOU) CO., LTD., Zhengzhou (CN); FOXCONN INTERCONNECT TECHNOLOGY LIMITED, Grand Cayman (KY)

(72) Inventors: Qin-Xin CAO, Kunshan (CN); Jui-Hsianh CHIU, New Taipei (TW)

(21) Appl. No.: 18/775,281

(22) Filed: Jul. 17, 2024

(30) Foreign Application Priority Data
Jul. 19, 2023 (CN) 202310908824.8
Jul. 19, 2023 (CN) 202321948051.8

(51) Int. Cl. H01R 13/6587; H01R 12/73; H01R 13/514

(52) U.S. Cl. CPC H01R 13/6587; H01R 12/737; H01R 13/514

(57) ABSTRACT

An electrical connector includes an outer frame and an inner connector assembly. The inner connector assembly includes: a mating frame with a vertical mating slot; two vertical terminal modules fixed together and received in the mating frame, each terminal module including an insulating housing and a row of terminals protruding into the mating slot and located at two sides of the mating slot, each row of the terminals including plural pairs of signal terminals and plural grounding terminals; a shielding member attached to a side of the insulating housing; and an absorbing member attached to a side of the shielding member away from the terminals, wherein the shielding member includes plural grounding fingers pressing against corresponding grounding terminals, and the absorbing member covers at least a part of the shielding member while has no contact with the grounding terminals.

### BACKGROUND OF THE INVENTION

### Field of the Invention

The present invention relates generally to an electrical connector, and particularly to an orthogonal electrical connector with improved high frequency performance.

### Description of Related Arts

U.S. Patent Publication No. 2024/0128667 discloses a card edge connector. The card edge connector comprises plural subassemblies each comprising a plurality of ground conductors and a plurality of differential signal conductors. Each subassembly further comprises an outer shield and an inner shield attached to an outer side and an inner side thereof and a lossy member. The lossy member passes through the ground conductors to connect both the outer shield and the inner shield to form a shielding frame.

It is desired to provide an improved electrical connector with high-frequency performance.

### SUMMARY OF THE INVENTION

The object of the present invention is to provide an improved electrical connector with high-frequency performance.

To achieve the above object, an electrical connector comprises: an outer frame; and an inner connector assembly partially retained in the outer frame and comprising: a mating frame with a vertical mating slot; two vertical terminal modules fixed together and received in the mating frame, each terminal module comprising an insulating housing and a row of terminals retained in the insulating housing, each terminal comprising a contacting portion, a tail portion, and a middle portion between the contacting portion and the tail portion and embedded in the insulating housing, the contacting portions of the terminals of the two terminal modules protruding into the mating slot and being located at two sides of the mating slot, each row of the terminals comprising plural pairs of signal terminals and plural grounding terminals; a shielding member attached to a side of the insulating housing; and an absorbing member attached to a side of the shielding member away from the terminals, wherein the shielding member comprises plural grounding fingers pressing against corresponding grounding terminals, and the absorbing member covers at least a part of the shielding member while has no contact with the grounding terminals.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of this present invention;

FIG. 2 is an exploded perspective view of the electrical connector of FIG. 1;

FIG. 3 is a further exploded perspective view of the electrical connector of FIG. 2;

FIG. 4 is a perspective view of a row of terminals;

FIG. 5 a perspective view of the row of terminals retained in an insulating housing;

FIG. 6 is a perspective view of two shielding assemblies, and one is exploded;

FIG. 7 is a perspective view of a terminal module;

FIG. 8 is an exploded perspective view of the terminal module wherein an absorbing member is removed;

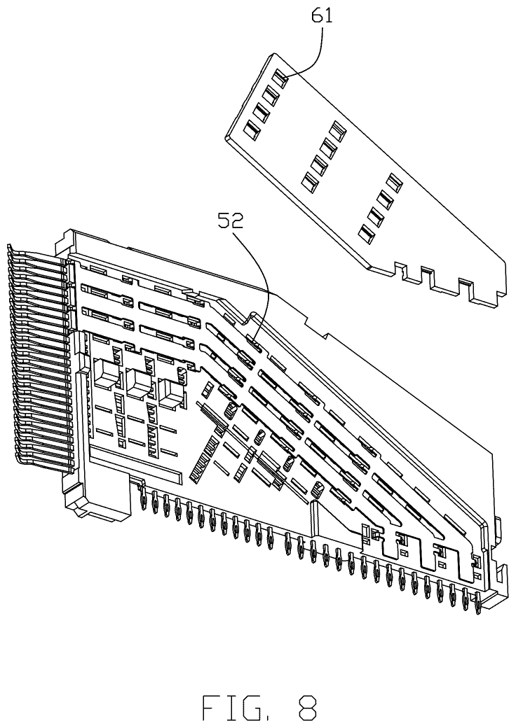

FIG. 9 is a perspective view of the row of terminals and a shielding member covering behind the terminals;

FIG. 10 is a perspective view of the row of terminals and the shielding member covering in front of the terminals; and

FIG. 11 is a cross-sectional view of the electrical connector taken along line A-A in FIG. 3.

### DETAILED DESCRIPTION OF THE PREFERRED EMBODIMENT

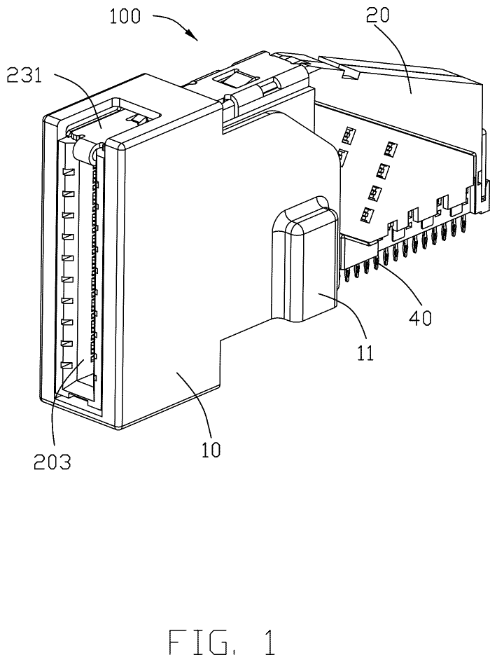

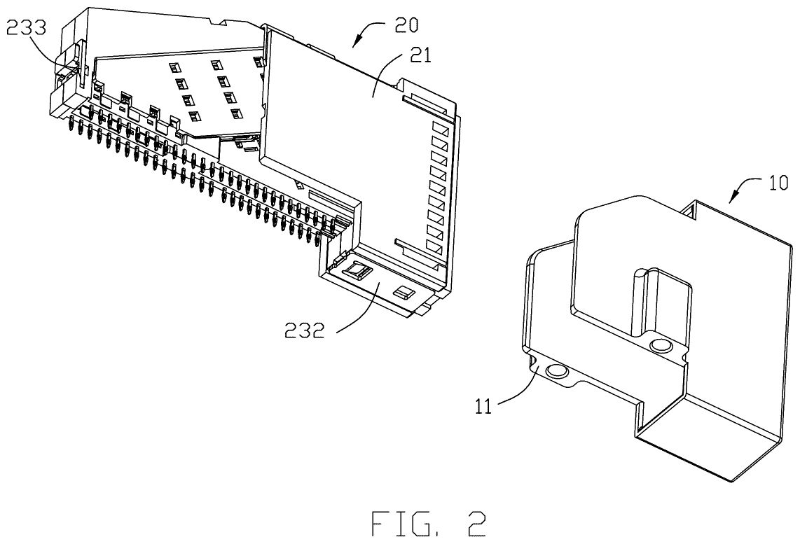

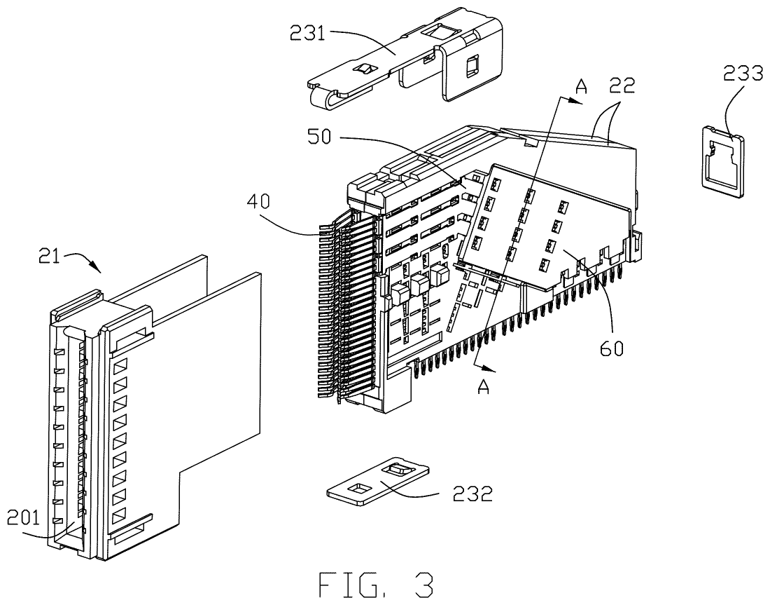

Referring to FIG. 1, an electrical connector 100 is illustrated, which is adapted for connecting EDSFF (Enterprise and Datacenter Small Form Factor) Modules to a circuit board in this embodiment. The electrical connector 100 is of an orthogonal type as the EDSFF module and the circuit board is perpendicular to each other. Alternatively, the electrical connector 100 may be adapted for other type electric modules Referring to FIGS. 1-3, the electrical connector 100 comprises an outer frame 10 and an inner connector assembly 20, the outer frame 10 surrounds a front end of the inner connector assembly 20 and has a fixing portion 11 for fixing on the circuit board. The outer frame 10 can be made from conductive metal. The front end of the inner connector assembly 20 has a mating slot 201, two rows of conductive terminals 40 retained at two sides of the mating slot 201 respectively with front ends thereof protruding into the mating slot 201 for contacting with the inserting electric module. The inner connector assembly 20 comprises a mating frame 21 with the mating slot 201, and a pair of terminal modules 22. The two terminal modules 22 are fixed together by fasteners 231, 232, 233 firstly to form a whole module assembly and then the whole module assembly is inserted into the mating frame 21 until the front ends of the terminals 40 are exposed in the mating slot 201. The two terminal modules 22 are in symmetry with each in a left-right direction particular to a front-rear direction. The terminal module in this embodiment is a type of wafer. The fasteners 231, 232 233 are disposed at an upper face, lower face and a rear face of the whole module assembly respectively to fix the two terminal modules 22 together from different positions. The fasteners 231 can also fix the whole module assembly to the mating frame 21. The whole module assembly has a shielding member 50 made of metal plates and an absorbing member 60 made of absorbing material distributed at one or two side faces thereof.

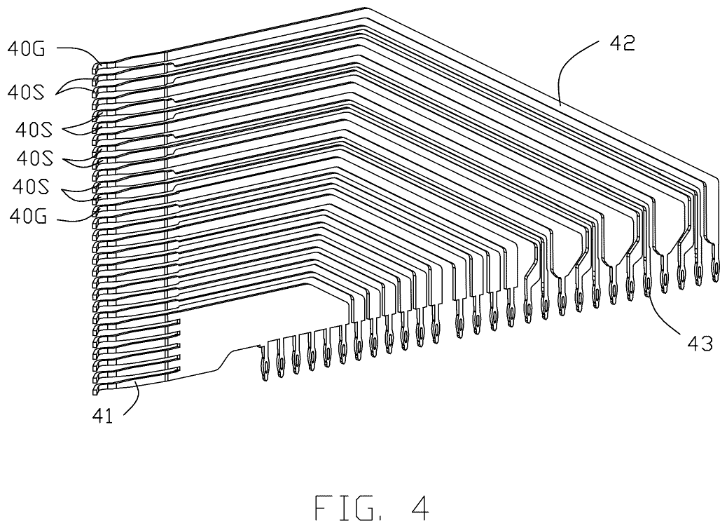

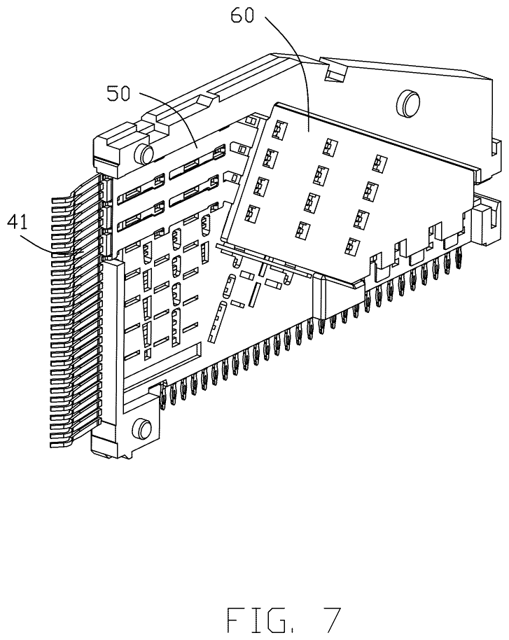

Referring to FIGS. 4-7, the terminal module 22 will be introduced in detail hereinafter. Each terminal module 22 comprises an insulating housing 30, a row of terminals 40, the shielding member 50 and the absorbing member 60. Each terminal 40 comprises a contacting portion 41 extending out of a front end of the insulating housing 30, a tail portion 43 extending out of a lower face of the insulating housing 30 and a middle portion 42 between the tail portion 43 and the contacting portion 41. The middle portions 42 are embedded in insulating housing 30, and the insulating housing 30 is partially hollowed so that part of the terminals are exposed to an exterior of the insulating housing 30. The insulating housing 30 is fixed with the terminals 40 arranged in a row by injection, leaving the tail portion 43 and the contacting portion 41 exposed to an outside of the insulating housing 30. Each insulating housing 30 has two vertical sides, and the row of terminals 40 are retained and located between corresponding two vertical sides. Each row of terminals 40 comprises at least two adjacent pairs of signal terminals 40S and a grounding terminal 40G between the two pairs of signal terminals 40S. Two adjacent signal terminals of each pair of signal terminals 40S are used for transmitting differential signals. In this embodiment, the row of terminals 40 has four pairs of signal terminals 40S and plural grounding terminals 40G. Every two neighboring pairs of signal terminals 40S are spaced by a grounding terminal 40G. Other terminals can be set as needed, such as detecting terminals, power terminals and so on. Referring to FIG. 4, the contacting portions 41 in the same row are in a same vertical plane, and the tail portions 43 in the same row are with same fish-eye shaped structure. The middle portions 42 of the pair of signal terminals 40S are thinner than the contacting portions 41, two inner side edges of the two middle portions 42 that are closer to each other, extend from corresponding contacting portion 41 smoothly while two outer side edges of the two middle portions away from each other, extend inward sharply from corresponding contacting portions 41.

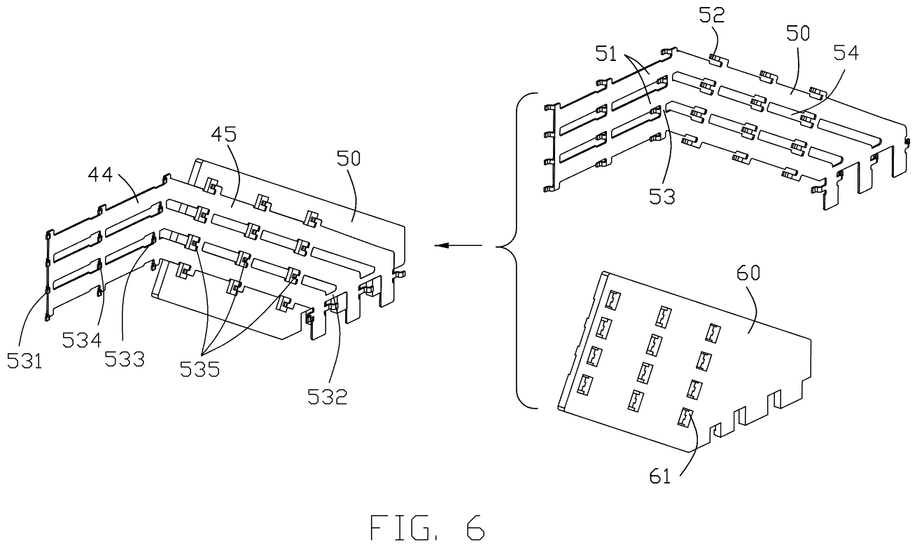

Combined with FIGS. 6 and 9-10, the shielding member 50 comprises shielding portions 51 facing corresponding pairs of signal terminals 40S and grounding fingers 52 resisting against with corresponding grounding terminals 40G. The absorbing member 60 covers at least part of an outer side of the shielding member 50 away from the terminals 40 and has no contact with the grounding terminals 40G. The absorbing member 60 has magnetic permeability and magnetic loss property which can consume the electric field and magnetic field of the terminals 40 in a transmission path to reduce crosstalk. In this embodiment, two adjacent shielding portions 51 are spaced apart from each other by a row of hollow portions 54 but connected with each other by bridge portions 53 spanning across the hollow portion 54. Each shielding portion 51 faces a corresponding pair of signal terminals 40S while each hollow portion faces a corresponding grounding member 40G. Plural grounding fingers 52 extend from the bridge portions 53. The grounding fingers 52 between two neighboring shielding portions 51 contact with a same grounding terminal 40G to short a length of a resonant cavity by multiple contacting points, and thus, an improved high-frequency performance of the connector 100 may be got.

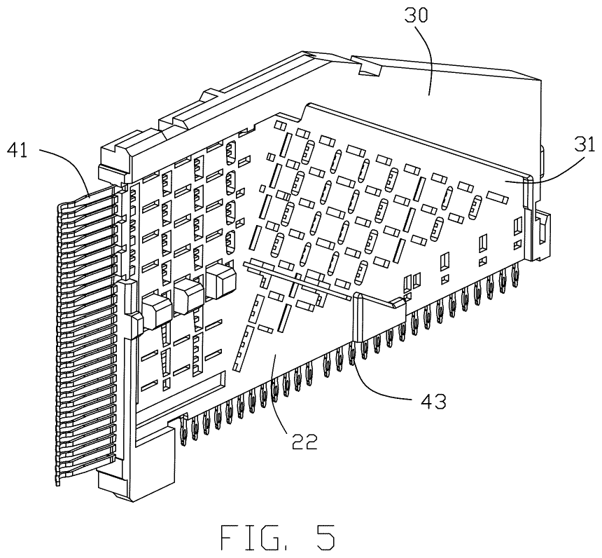

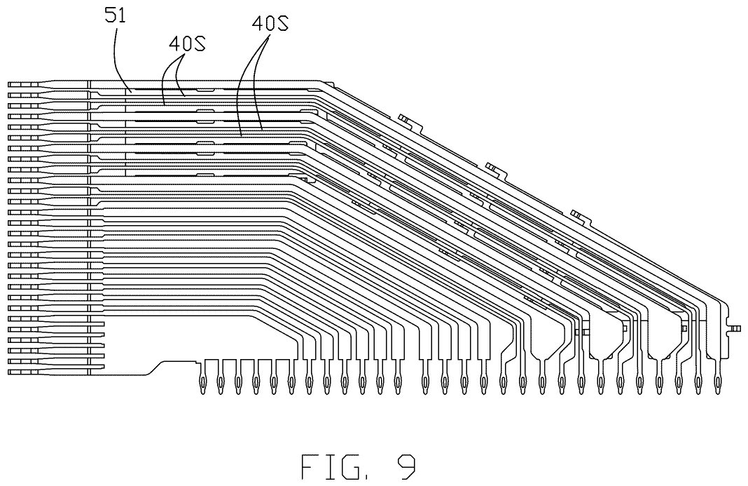

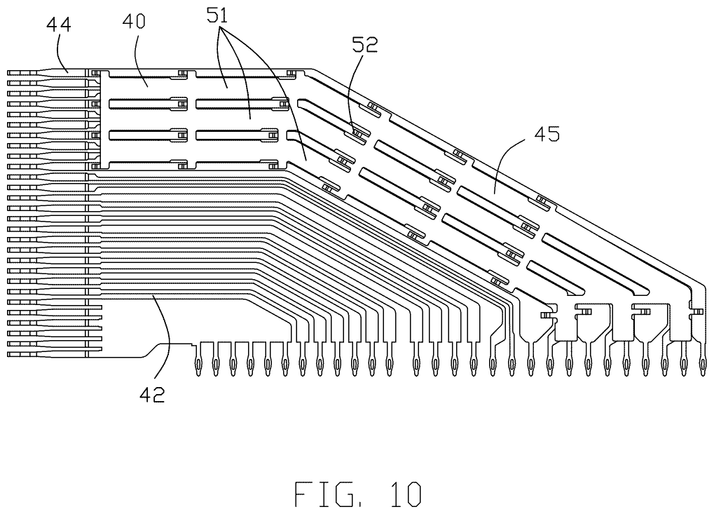

Combined with FIGS. 4-5, the insulating housing 30 is of a wafer, terminals 40 of each row are arranged in an upper and down direction, and lengths of terminals 40 of each row gradually shorten from an upper to lower direction. The contacting portions 41 are aligned with each other and are in the same plane and the middle portions 42 are in another same plane when seen from a top view, lengths of the middle portions 42 gradually shorten from the upper to lower direction. The tail portions 43 are aligned with each other and lined up in a row when seen from a front to rear direction. In this embodiment, each row of the terminals 40 comprises four pairs of signal terminals 40S and plural grounding terminals 40G, every two adjacent pairs of signal terminals 40S are spaced by one grounding terminal 40G and each side of one pair of signal terminals 40S has one grounding terminal 40G. The shielding member 50 has three shielding portions 51, and the grounding fingers 52 are located at two sides of each shielding portion 51. Referring to FIGS. 9-10, the three shielding portions 51 face three pairs of signal terminals 40s at the upper respectively, and the pair of signal terminals 40s located at the lower is not covered by the shielding portion 51. As the lowest pair of signal terminals 40S of the four pairs of signal terminals 40S is the shortest one, it can meet the electrical requirements even if it is not covered by the shielding portion. In other embodiments, the lowest pair of signal terminals 40S can also be covered with shielding portion 51 as other three pairs of signal terminals 40. Preferably, for matching with the signal terminal 40S, the shielding portion 51 comprises a horizontal portion 44 and an inclined portion 45. The shielding portion 51 has a front bridge portion 531 at a front end and a rear bridge portion 532 at a rear end thereof respectively. In addition, the shielding portion 51 has a middle bridge portion 533 at a connecting portion between the horizontal portion 44 and the inclined portion 45. Furthermore, the horizontal portions 44 are further united with a bridge portion 534 located between the front bridge portion 531 and the middle bridge portion 533, and the inclined portions 45 are further united with three bridge portions 535 located between the middle bridge portion 533 and the rear bridge portion 532. Combined with FIG. 6, the grounding fingers 52 extend from front side edges of all the bridges portions except for the rear bridge portion 532. The absorbing member 60 covers four pairs of signal terminals. The shielding member 50 is attached to a vertical side 31 of the insulating housing 30 and the absorbing member 60 is further attached to the outside face of the shielding member 50.

In this embodiment, the grounding tail 52 and corresponding grounding terminal 40G are fixed together by laser spot welding. The absorbing member 60 has many holes 61 corresponding to the grounding tails 52 one by one for spot welding. The shielding member 50 are pressed by a tool to make the grounding tails 52 closely resist against the corresponding grounding terminal 40G before spot welding the grounding tail 52 and the grounding terminal 40G to avoid the risk of poor contact between the grounding tail 52 and the grounding terminal 40G.

In this embodiment, firstly, the absorbing member 60 is combined with the shielding member 50 by injection molding to form a shielding and absorbing assembly; secondly, the shielding and absorbing assembly is attached to the vertical side 31; thirdly, spot welding the grounding tails 52 and the grounding terminals 40G together. In other embodiments, the shielding member 50 can be fixed to the vertical side 31 firstly, and then attach the absorbing member 60 to the shielding member 50 or injection molding the absorbing member 60 to the shielding member 50. In this embodiment, both the two vertical sides of each terminal module are attached with the shielding and absorbing assembly respectively to meet high-frequency electrical performance, especially far-end crosstalk performance requirements

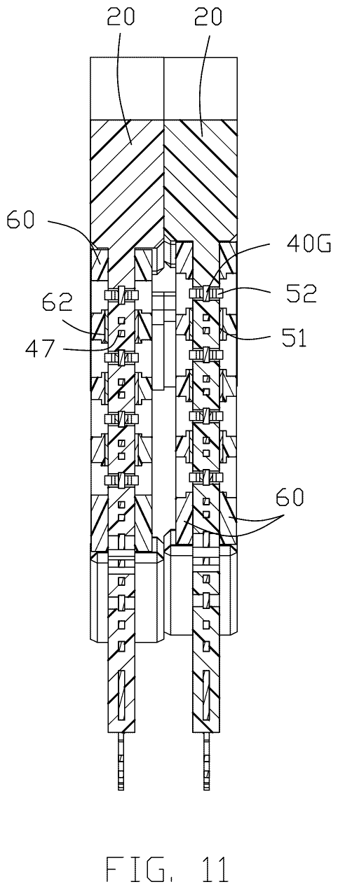

A certain distance between the absorbing member and the corresponding signal terminal 40G is not less than 0.3 mm for avoiding interference of normal signals. As clearly shown in FIG. 11, a distance between an inner side 62 of the absorbing member 60 and a side 47 of the signal terminal 40S facing the absorbing member 60 is not less than 0.3 mm. The absorbing member 60 does not cover the whole middle portions 42, that is, the absorbing member 60 only covers partial middle portions 42 of terminals 40. The absorbing member 60 only covers the middle portions 42 that face the inclined portions 45 of the shielding member 50 for meeting the requirement of absorbing noise but not affecting normal signals.

In summary, the electrical connector 100 comprises at least one terminal module 22, and each terminal module 22 comprises the insulating housing 30 with two opposite vertical sides, one row of terminals 40 retained in the insulating housing 30, and the absorbing member 60 made of absorbing material. Each terminal 40 comprises the contacting portion 41 extending out of the front face of the insulating housing 30, the tail portion 43 extending out of the lower face of the insulating housing 30 and the middle portion 42 between the tail portion 43 and the contacting portion 41. The middle portions 42 are embedded in the insulating housing 30. One row of the terminals 40 comprises at least two pairs of signal terminal 40S and at least one grounding terminal 40G between the two pairs of signal terminals 40S. The absorbing member 60 is attached to one side of the insulating housing 30 and does not contact the grounding terminal 40G. The distance between the middle portion 42 and the absorbing member 60 is not less than 0.3 mm. In addition, the electrical connector 100 further comprises the shielding member 50 made of metal, the shielding member 50 has the grounding fingers 52 which resist against the grounding terminals 40G and is attached to one side of the insulating housing 30 too, and the absorbing member 60 covers at least part of an outside face of the shielding member 50.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an outer frame; and
an inner connector assembly partially retained in the outer frame and comprising:
a mating frame with a vertical mating slot;
two vertical terminal modules fixed together and received in the mating frame, each terminal module comprising an insulating housing and a row of terminals retained in the insulating housing, each terminal comprising a contacting portion, a tail portion, and a middle portion between the contacting portion and the tail portion and embedded in the insulating housing, the contacting portions of the terminals of the two terminal modules protruding into the mating slot and being located at two sides of the mating slot, each row of the terminals comprising plural pairs of signal terminals and plural grounding terminals;
a shielding member attached to a side of the insulating housing; and
an absorbing member attached to a side of the shielding member away from the terminals;
wherein the shielding member comprises plural grounding fingers pressing against corresponding grounding terminals, and the absorbing member covers at least a part of the shielding member while has no contact with the grounding terminals.

2. The electrical connector as claimed in claim 1, wherein the shielding member comprises plural shielding portions facing and shielding corresponding pairs of the signal terminals and a hollow portion located between two adjacent shielding portions and facing corresponding grounding terminal.

3. The electrical connector as claimed in claim 2, wherein two adjacent shielding portions are connected by bridge portions spanning over the hollow portion, and the grounding fingers extend from corresponding bridge portions.

4. The electrical connector as claimed in claim 1, wherein a side of the middle portion of the signal terminals and a side of the absorbing member which face to each other are spaced with a distance that is greater than 0.3 mm.

5. A terminal module comprising:
an insulating housing with two opposite vertical sides;
a row of terminals retained in the insulating housing, each terminal comprising a contacting portion extending out of a front end of the insulating housing, a tail portion extending out of a lower end of the insulating housing, and a middle portion between the tail portion and the contacting portion, the middle portion being embedded in the insulating housing, the row of terminals comprising at least two grounding terminals and one pair of differential terminals between the at least two grounding terminals; and
an absorbing member being attached to one vertical side of the insulating housing to cover at least partially of the middle portions of the terminals;
wherein the absorbing member has no contact with the terminals, and a distance between two nearest sides of the absorbing member and the middle portion is greater than 0.3 mm.

6. The terminal module as claimed in claim 5, wherein the middle portion comprises a horizontal portion connecting with the contacting portion and an inclined portion extending obliquely from the horizontal portion to the tail portion, and the absorbing member covers the inclined portions of the terminals.

7. The terminal module as claimed in claim 6, further comprising a shielding member made of metal material, and wherein the shielding member comprises at least one shielding portion attached to the vertical side of the insulating housing and shielding the pair of differential terminals and plural grounding fingers mechanically connecting with corresponding grounding terminals respectively, and the absorbing member is attached to the shielding member.

8. The terminal module as claimed in claim 7, wherein the grounding fingers and corresponding grounding terminals are fixed by laser spot welding.

9. A terminal wafer comprising:
an insulative housing;
a row of terminals retained in the insulative housing, each terminal comprising a contacting portion extending out from a front end of the insulative housing, a tail portion extending out from a bottom end of the insulative housing, and a middle portion between the contacting portion and the tail portion and embedded in the insulative housing, the row of the terminals comprising plural pairs of differential terminals and plural grounding terminals alternately arranged; and
a shielding member and an absorbing member;
wherein the shielding member comprises plural shielding portions located at a vertical side of the insulating housing to align with and shield the plural pairs of differential terminals and plural grounding fingers contacting with corresponding grounding terminals; and
wherein the absorbing member is attached to the shielding member and at least partially covers the shielding member.

10. The terminal wafer as claimed in claim 9, wherein the absorbing member is separated from the grounding terminals by the shielding member.

11. The terminal wafer as claimed in claim 9, wherein two adjacent shielding portions are spaced apart from each other by a hollow portion and connected by plural bridge portions, and the grounding terminals are exposed to corresponding hollow portions, the shielding portions do not cover the grounding terminals, the plural grounding fingers extend from the bridge portions, and the grounding fingers between two adjacent pairs of signal terminals contact the grounding terminal at different positions.

12. The terminal wafer as claimed in claim 9, wherein the middle portion comprises a horizontal portion connecting with the contacting portion and an inclined portion forming an angle with respect to the horizontal portion, and the shielding portion covers both the horizontal portion and the inclined portion while the absorbing portion only covers the inclined portion.

13. The terminal wafer as claimed in claim 9, wherein the shielding member and the absorbing member are fixed together as a shielding and absorbing assembly firstly, and then two shielding and absorbing assemblies are fitly stacked to the two corresponding vertical sides side by side respectively.

14. The terminal wafer as claimed in claim 13, wherein the shielding and absorbing assembly is retained by spot welding the grounding fingers to corresponding grounding terminals.

15. The terminal wafer as claimed in claim 10, wherein the middle portions of the differential terminals and the absorbing member are spaced from each other by a distance that is greater than 0.3 mm.
